(19) United States
(12) Patent Application Publication
(10) Pub. No.: US 2024/0172283 A1
(43) Pub. Date: May 23, 2024

(54) METHODS AND NODES IN A COMMUNICATIONS NETWORK

(71) Applicant: Telefonaktiebolaget LM Ericsson (publ), Stockholm (SE)

(72) Inventors: Abdulrahman ALABBASI, Kista (SE); Henrik RYDÉN, Stockholm (SE); Hazhir SHOKRI RAZAGHI, Solna (SE); Alexandros PALAIOS, Herzogenrath (DE); Reza MOOSAVI, Linköping (SE)

(21) Appl. No.: 18/551,050

(22) PCT Filed: Apr. 8, 2021
(86) PCT No.: PCT/EP2021/059245

§ 371 Date: Sep. 18, 2023

(51) Int. Cl. H04W 74/0816; G06N 3/092; H04L 41/16; H04W 24/02; H04W 28/02

(52) U.S. Cl. CPC H04W 74/0816; G06N 3/092; H04L 41/16; H04W 24/02; H04W 28/0252

(57) ABSTRACT

A computer implemented method performed by a first node in a communications network for use in determining whether a channel between the first node and a target node is in use. The method includes selecting, from a plurality of other nodes that are suitable for making measurements on the channel, a subset of the other nodes from which to obtain channel information in order to determine whether the channel is in use. The selection is performed using a first model trained using a first machine learning process to select the subset of other nodes based on accuracy of the resulting determination of whether the channel is in use. The method then includes sending a message to cause the subset of other nodes to obtain the channel information.

### TECHNICAL FIELD

This disclosure relates to methods, nodes and systems in a communications network. More particularly but non-exclusively, the disclosure relates to determining whether a channel is in use.

### BACKGROUND

5G New Radio-Unlicensed (NR-U) extends 5G NR to unlicensed bands (see, for example, 3GPP TR 38.889, entitled “Study on NR-based access to unlicensed spectrum”). In NR-U (standalone (SA) or Licensed Assisted Access (LAA)), spectrum sensing is part of the specification to secure accurate media access with minimum interference. UEs and gNBs are required to perform the so-called Listen-Before-Talk (LBT) procedure before making transmissions to ensure the channel is not acquired by another device. The LBT procedure is described in technical specification TS 37.213 entitled: “Physical layer procedures for shared spectrum channel access”.

In LBT, a radio transmitter first senses its radio environment before starting a transmission to find a free channel. The accuracy of LBT can be enhanced through distributed sensing where a plurality of nodes listen to a channel and combine their collected insights to provide a more accurate determination of whether a channel is in use, before the transmitter transmits over the channel.

### SUMMARY

The LBT stage (of NR-U) can face a hidden node issue that is illustrated in FIG. 1. FIG. 1 shows a base station 102 in communication with six nodes N1-N6. There is a blockage between N1 and N2, which might be, for example, a physical blockage (buildings, geographical feature etc). Defining the detection accuracy as the probably of correctly detecting the signal and activities of other nodes (uplink or downlink signals), it is clear that the weaker the received signal, the lower the detection accuracy. Hence, with reference to FIG. 1, signals from N2-to-N1 and N4-to-N1 are weaker than the signal from N6-to-N1 due to the presence of the blockage. Therefore, the detection accuracy of N2 and N4 UL signals at N1 node is less accurate, and hence less credible, than that of the N6 signal at N1.

Thus, it can be shown that the sensing data of N2 about N1 and N6 is not accurate (this not accurate sensing information can be from any node or even from gNB), however, sensing info of N6 about N1 is more accurate.

Current collaborative sensing methods generally take information from all nodes capable of making measurements on a channel into account when determining whether a channel is available or already in use.

Current methods therefore do not take decisions on how to collect sensing data in a very efficient manner for the following reasons:

Existing collaborative sensing algorithms tend to exhaust the network, due to the exchange of large amounts of sensed data from all sensors/nodes.

Existing collaborative sensing techniques do not learn from historical accuracy levels of nodes contributing to the decision making process. For example, all nodes contribute to the decision, irrespective of whether they have previously provided accurate information or not. And all nodes contribute the same type of data to the decision making process, irrespective of whether that information is the most appropriate measurement for an individual node to have made.

There is also no general framework that jointly considers several parameters (described as input parameters) to optimally decide on the above aspects.

It is an object of embodiments herein to address some of these issues, amongst others.

According to a first aspect herein there is a computer implemented method performed by a first node in a communications network for use in determining whether a channel between the first node and a target node is in use. The method comprises selecting, from a plurality of other nodes that are suitable for making measurements on the channel, a subset of the other nodes from which to obtain channel information in order to determine whether the channel is in use. The selection is performed using a first model trained using a first machine learning process to select the subset of other nodes based on accuracy of the resulting determination of whether the channel is in use. The method further comprises sending a message to cause the subset of other nodes to obtain the channel information.

According to a second aspect there is a first node in a communications network for determining whether a channel between the first node and a target node is in use. The first node is configured to select, from a plurality of other nodes that are suitable for making measurements on the channel, a subset of the other nodes from which to obtain channel information in order to determine whether the channel is in use. The selection is performed using a first model trained using a first machine learning process to select the subset of other nodes based on accuracy of the resulting determination of whether the channel is in use, and send a message to cause the subset of other nodes to obtain the channel information.

According to a third aspect there is a first node in a communications network for determining whether a channel between the first node and a target node is in use. The first node comprises a memory comprising instruction data representing a set of instructions, and a processor configured to communicate with the memory and to execute the set of instructions. The set of instructions, when executed by the processor, cause the processor to select, from a plurality of other nodes that are suitable for making measurements on the channel, a subset of the other nodes from which to obtain channel information in order to determine whether the channel is in use. The selection is performed using a first model trained using a first machine learning process to select the subset of other nodes based on accuracy of the resulting determination of whether the channel is in use. The set of instructions further cause the first node to send a message to cause the subset of other nodes to obtain the channel information.

According to a fourth aspect there is a computer program comprising instructions which, when executed on at least one processor, cause the at least one processor to carry out a method according to the first aspect.

According to a fifth aspect there is a carrier containing a computer program according to the first aspect, wherein the carrier comprises one of an electronic signal, optical signal, radio signal or computer readable storage medium.

According to a sixth aspect there is a computer program product comprising non transitory computer readable media having stored thereon a computer program according to the first aspect.

Thus, the methods and nodes herein allow for distributed sensing in a LBT procedure using only a subset of nodes available for performing sensing on a channel, the subset being selected based on (predicted or estimated) accuracy of the resulting determination of whether the channel is in use, as made using the selected subset of nodes. This increases accuracy of the resulting determination of channel usage and also saves on network resources, as fewer nodes are involved in obtaining and sending channel information around the communications network.

### BRIEF DESCRIPTION OF THE DRAWINGS

For a better understanding and to show more clearly how embodiments herein may be carried into effect, reference will now be made, by way of example only, to the accompanying drawings, in which:

FIG. 1 shows a prior art collaborative sensing method;

FIG. 2 shows a node according to some embodiments herein;

FIG. 3 shows a method according to some embodiments herein;

FIG. 4 shows a signaling diagram according to some embodiments herein; and

FIG. 5 shows a method in a second node according to some embodiments herein.

### DETAILED DESCRIPTION

The disclosure herein relates to a communications network (or telecommunications network). A communications network may comprise any one, or any combination of: a wired link (e.g. ASDL) or a wireless link such as Global System for Mobile Communications (GSM), Wideband Code Division Multiple Access (WCDMA), Long Term Evolution (LTE), New Radio (NR), WiFi, Bluetooth or future wireless technologies. The skilled person will appreciate that these are merely examples and that the communications network may comprise other types of links. A wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

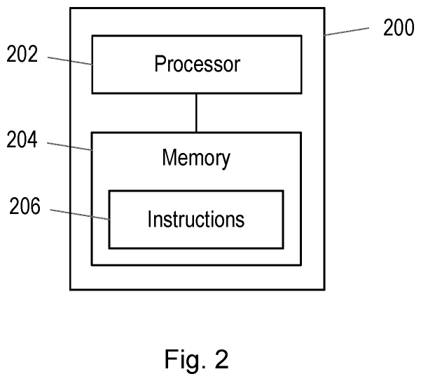

FIG. 2 illustrates a network node 200 in a communications network according to some embodiments herein. Generally, the node 200 may comprise any component or network function (e.g. any hardware or software module) in the communications network suitable for performing the functions described herein. For example, a node may comprise equipment capable, configured, arranged and/or operable to communicate directly or indirectly with a UE (such as a wireless device) and/or with other network nodes or equipment in the communications network to enable and/or provide wireless or wired access to the UE and/or to perform other functions (e.g., administration) in the communications network. Examples of nodes include, but are not limited to, access points (APs) (e.g., radio access points), base stations (BSs) (e.g., radio base stations, Node Bs, evolved Node Bs (eNBs) and NR NodeBs (gNBs)). Further examples of nodes include but are not limited to core network functions such as, for example, core network functions in a Fifth Generation Core network (5GC).

The node 200 is configured (e.g. adapted, operative, or programmed) to perform any of the embodiments of the method 200 as described below. It will be appreciated that the node 200 may comprise one or more virtual machines running different software and/or processes. The node 200 may therefore comprise one or more servers, switches and/or storage devices and/or may comprise cloud computing infrastructure or infrastructure configured to perform in a distributed manner, that runs the software and/or processes.

The node 200 may comprise a processor (e.g. processing circuitry or logic) 202. The processor 202 may control the operation of the node 200 in the manner described herein. The processor 202 can comprise one or more processors, processing units, multi-core processors or modules that are configured or programmed to control the node 200 in the manner described herein. In particular implementations, the processor 202 can comprise a plurality of software and/or hardware modules that are each configured to perform, or are for performing, individual or multiple steps of the functionality of the node 200 as described herein.

The node 200 may comprise a memory 204. In some embodiments, the memory 204 of the node 200 can be configured to store program code or instructions 206 that can be executed by the processor 202 of the node 200 to perform the functionality described herein. Alternatively or in addition, the memory 204 of the node 200, can be configured to store any requests, resources, information, data, signals, or similar that are described herein. The processor 202 of the node 200 may be configured to control the memory 204 of the node 200 to store any requests, resources, information, data, signals, or similar that are described herein.

It will be appreciated that the node 200 may comprise other components in addition or alternatively to those indicated in FIG. 2. For example, in some embodiments, the node 200 may comprise a communications interface. The communications interface may be for use in communicating with other nodes in the communications network, (e.g. such as other physical or virtual nodes). For example, the communications interface may be configured to transmit to and/or receive from other nodes or network functions requests, resources, information, data, signals, or similar. The processor 202 of node 200 may be configured to control such a communications interface to transmit to and/or receive from other nodes or network functions requests, resources, information, data, signals, or similar.

Briefly, in one embodiment, the node 200 may be configured to select, from a plurality of other nodes that are suitable for making measurements on the channel, a subset of the other nodes from which to obtain channel information in order to determine whether the channel is in use. The selection is performed using a first model trained using a first machine learning process to select the subset of other nodes based on accuracy of the resulting determination of whether the channel is in use, and send a message to cause the subset of other nodes to obtain the channel information.

Thus in this manner, a node may select a subset of available nodes for use in determining whether a channel is in use, based on the estimated or predicted accuracy of a determination using said subset of nodes. In this way, a subset may be chosen so as to improve accuracy whilst reducing the number of nodes involved in the collaborative sensing, thus reducing overhead on the communications network.

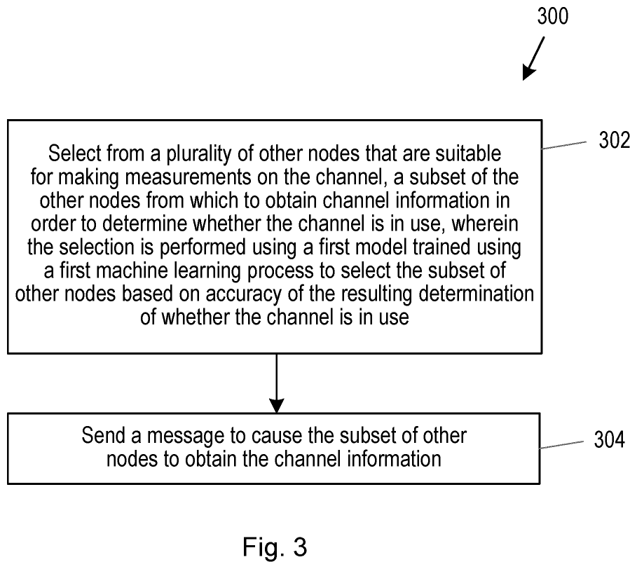

Turning now to FIG. 3, there is a computer implemented method 300 performed by a first node (such as the node 200) in a communications network for use in determining whether a channel between the first node and a target node is in use. Briefly in a first step 302 the method comprises selecting, from a plurality of other nodes that are suitable for making measurements on the channel, a subset of the other nodes from which to obtain channel information in order to determine whether the channel is in use. The selection is performed using a first model trained using a first machine learning process to select the subset of other nodes based on accuracy of the resulting determination of whether the channel is in use. In a second step 304 the method comprises sending a message to cause the subset of other nodes to obtain the channel information.

In more detail, the method 300 is for use in determining whether a channel is in use (e.g. or available for use) by the first node and the target node for sending traffic between the first node and the target node. The method 300 may be performed as part of a LBT procedure. The LBT procedure may be a collaborative, or distributed LBT procedure. The method may generally be used when accessing New Radio-Unlicenced (NR-U) spectrum.

The channel or communications channel may refer to a logical connection that takes place in a particular frequency bandwidth between the first node and the target node.

The target node may be any other node in the communications network. For example, any of the types of nodes as described with respect to the first node 200 as described above. For example, another base station, eNodeB or gNodeB etc.

In other examples, the target node may be a user equipment (UE). The skilled person will be familiar with UEs, but generally, a UE may comprise any device capable, configured, arranged and/or operable to communicate wirelessly with network nodes and/or other wireless devices. Examples of a UE include, but are not limited to, a smart phone, a mobile phone, a cell phone, a voice over IP (VOIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A UE may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IOT) scenario, a UE may represent a machine or other device that performs monitoring and/or measurements, and transmits the results of such monitoring and/or measurements to another UE and/or a network node. The UE may in this case be a machine-to-machine (M2M) device, which may in a 3GPP context be referred to as an MTC device. As one particular example, the UE may be a UE implementing the 3GPP narrow band internet of things (NB-IOT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a UE may represent a vehicle or other equipment that is capable of monitoring and/or reporting on its operational status or other functions associated with its operation.

In step 302 of the method 300, as noted above, the method comprises selecting, from a plurality of other nodes that are suitable for making measurements on the channel, a subset of the other nodes from which to obtain channel information in order to determine whether the channel is in use. The other nodes may be any other nodes in the communications network and of any type or combination of types. For example, the other nodes may comprise base stations, eNBs, gNBs and/or UEs as described above with respect to the first node and the target node.

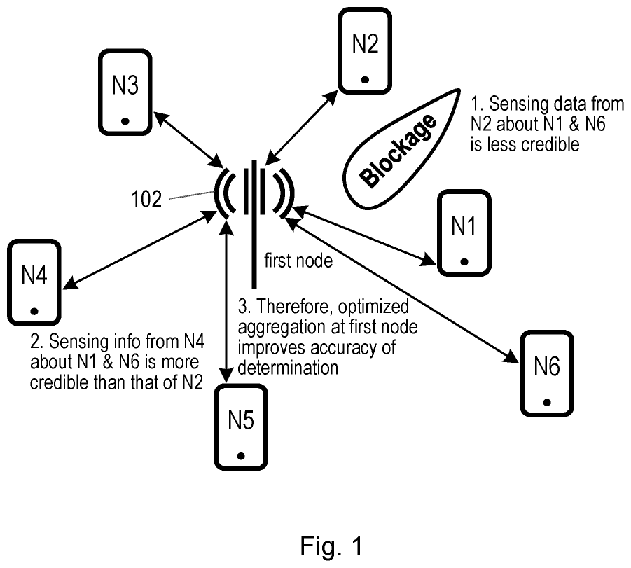

The other nodes can make measurements on the channel, for example such as interference measurements. Some of the other nodes may be more appropriate for making accurate measurements than others, for example, due to blockages as illustrated in FIG. 1. In step 302 a subset of the other nodes are selected for use in determining whether the channel is available for use for sending traffic between the first node and the target node.

The selection is performed using a first model trained using a first machine learning process to select the subset of other nodes based on (predicted) accuracy of the resulting determination of whether the channel is in use.

The skilled person will be familiar with machine learning and models that can be trained using machine learning processes. When herein referring to a process and a model, what is referred to is generally a machine learning process (e.g. algorithm) and a machine learning model. A process, in the context of machine learning, may be defined as a procedure that is run on data to create a machine learning model. The machine learning processes comprises instructions through which data, generally referred to as training data, may be processed or used in a training process to generate a machine learning model. The machine learning process learns from the training data. In other words, the model is fitted to a dataset comprising training data. Machine learning algorithms can be described using math, such as linear algebra, and/or pseudocode, and the efficiency of a machine learning algorithm can be analyzed and quantized. There are many machine learning algorithms, such as e.g. algorithms for classification, such as k-nearest neighbors, algorithms for regression, such as linear regression or logistic regression, and algorithms for clustering, such as k-means. Further examples of machine learning algorithms are Decision Tree algorithms and Artificial Neural Network algorithms. Machine learning algorithms can be implemented with any one of a range of programming languages.

The model, or machine learning model, may comprise both data and procedures for how to use the data to e.g. make a prediction, perform a specific task or for representing a real-world process or system. The model represents what was learned by a machine learning algorithm when trained by using training data, and is what is generated when running a machine learning process. The model may represent e.g. rules, numbers, and any other algorithm-specific data structures or architecture required to e.g. make predictions. The model may e.g. comprise a vector of coefficients (data) with specific values (output from a linear regression algorithm), a tree of if/then statements (rules) with specific values (output of a decision tree algorithm) or a graph structure with vectors or matrices of weights with specific values (output of an artificial neural network applying backpropagation and gradient descent).

In some embodiments as will be explained in detail below, the first model is a classification model (such as a neural network) and the first machine learning process is a process such as, for example, a back propagation or gradient descent process.

In other embodiments as will be explained in detail below, the machine learning process is a reinforcement learning process and the first model is a reinforcement learning agent. The reinforcement learning process may be a process such as a Q-Learning process.

The first model is trained using the first machine learning process to select the subset of other nodes based on (e.g. a predicted, expected or learnt) accuracy of the resulting determination of whether the channel is in use. For example, the first model may be trained to select the subset of other nodes so as to maximise the accuracy of the resulting determination made from the channel information from the subset of nodes. E.g. by discarding nodes that are historically known to provide inaccurate information regarding the channel. As such the first model can be trained to select nodes that can (highly) contribute to the sensing output and discard the remaining nodes. The first model may thus be trained to select the subset of other nodes so as to optimise the accuracy of the resulting determination of whether the channel is in use.

In some embodiments other parameters or metrics may also be considered. For example, the accuracy may be optimised in terms of a trade-off with respect to one or more other parameters or metrics. As such, the first model may be further trained to select the subset of other nodes based on values of one or more other parameters. The first model may thus be trained to optimise (both) the accuracy of the resulting determination of whether the channel is in use and the values of the one or more other parameters. In other words, a trade-off may be performed between the accuracy and the one or more other parameters.

The one or more parameters may comprise parameter(s) related to overhead or cost associated with making the determination. Measures of overhead include but are not limited to measures such as: signalling overhead associated with making the determination; volume of traffic flow through the communications network associated with making the determination; computational energy used by the subset of nodes associated with making the determination; and/or energy efficiency associated with making the determination.

As such, the first machine learning model may be trained so as to select a subset of the other nodes that will provide channel information resulting in the most accurate determination of whether the channel is in use for the least overhead (e.g. lowest energy usage, least signalling overhead, lowest volume of traffic, lowest computational energy usage of the other nodes and/or most energy efficient determination).

In some embodiments, as noted above, the first model is a reinforcement learning agent. Generally the state information input to the reinforcement learning agent may comprise any parameters suitable for identifying the radio condition and traffic situation of the other nodes.

For example, the reinforcement learning agent input (e.g. state information) can comprise amongst others:
Historical success and fail rate of each other node in identifying whether the channel was accessible or not. This can be used to select historically more accurate nodes from the plurality of other nodes.
Distance between each other node and the target node. This can be used as an indicator of likely accuracy of channel information obtained by each other node (the nearer the other node is to the target node, the more likely that the channel information reported by the other node will be accurate)
Nodes traffic priority (e.g. traffic priority of the data to be transmitted once the channel is obtained for access). This may, for example, be used to influence the accuracy of the resulting determination. If the traffic priority is high, then the reinforcement learning agent may be encouraged to prioritise accuracy over other parameters.
Nodes transmission power, the subset of other nodes may be selected to avoid high interference.
Time since the last transmission, nodes with the most up to date channel information (lower time intervals from the last transmission) may be preferentially selected over nodes with out of date information (higher time intervals since the last transmission).
Available battery at the nodes, e.g. nodes with more battery power may be preferentially selected over those with less battery power.
Computational ability of the nodes, e.g. nodes with higher computational ability may be preferentially selected over nodes with lower computational ability.
Historical interreference level at each node from other nodes, cells, carriers, etc. For example, nodes experiencing lower interference may be preferentially selected over nodes experiencing higher interference.
Historical SINR level at each node for example, nodes with historically high SINR levels may be preferentially selected over nodes experiencing lower SINR.

The agent action space comprises different subsets of the plurality of other nodes (e.g. different combinations) that can be selected to transmit the channel information from which to determine whether the channel is in use.

The agent's reward function may encourage the reinforcement learning agent to select actions that minimise costs such as:
Number and volume of control signal transmission overhead, e.g., reduce network footprint,
Computation energy of each selected other node and/or overall computational energy of the selected subset of the other nodes when taken together, and/or
Delay in the decision-making.

The agent's reward function may further encourage the reinforcement learning agent to select actions that increase parameters (e.g. metrics) such as:
The detection accuracy,
Overall throughput of the system, or weighted sum throughput of the system (for instance to cater for scenarios where certain UEs have higher priority), and/or
QoS of each node.

The reward function sets a trade-off among the above metrics based on the importance of each metric. The system could for example set a high importance to a high detection accuracy in case that is more important than energy efficiency.

Put another way, the reinforcement learning agent takes as input state information, s, comprising one or more of:
historical success and/or fail rates of the plurality of other nodes in identifying whether the channel is accessible;
distances between the target node and the plurality of other nodes;
transmission powers of the plurality of other nodes;
power levels of the plurality of other nodes;
computational capabilities of the plurality of other nodes;
interreference levels experienced by the plurality of other nodes;
signal to noise levels at the plurality of other nodes;
a time interval since a previous transmission from the first node to the target node on the channel; and/or
an indication of a priority of traffic that is to be sent on the channel from the first node to the target node.

The step of selecting 202 is performed by the reinforcement learning agent as an action, a and the reinforcement learning agent is rewarded for the action based on the accuracy of the resulting determination of whether the channel is in use. For example, the reinforcement learning agent may receive a more positive reward, r, when the accuracy of the resulting determination is higher compared to when the accuracy of the resulting determination is lower. In other words, more positive rewards for selecting subsets of the other nodes that lead to more accurate determinations of whether the channel is in use or not.

As described above, a reinforcement learning agent may be rewarded so as to achieve a trade-off between accuracy and one or more other parameters (or metrics) such as metrics associated with overhead or cost associated with making the determination, as described above.

As such, the reinforcement learning agent may be further rewarded for the action based on the measure of overhead associated with determining whether the channel is in use using channel information from the selected subset of other nodes. For example, the reinforcement learning agent may generally receive a more positive reward, r, when overhead is reduced, e.g. when the overhead associated with making the determination is lower compared to when the overhead associated with making the determination is higher.

The one or more parameters may comprise parameters related to the throughput of the communications network and/or the quality of service experienced by users of the communications service. As such, the reinforcement learning agent may further receive a more positive reward, r, when the throughput of the communications network is higher as a result of the action compared to when the throughput is lower, and/or when quality of service is higher as a result of the action compared to when quality of service is lower as a result of the action.

In some embodiments, the reinforcement learning agent may receive a reward based on a reward function that rewards the reinforcement learning agent based on relative priorities of the accuracy and the values of the one or more other parameters, so as to apply a trade-off between the accuracy and the one or more parameters according to the relative priority of each parameter.

For example, the reward may be calculated as a weighted combination of the accuracy, and each of the one or more parameters (for each of the subset of nodes), where the weights of each term are scaled according to relative priority.

As an example, the reward may be calculated as a weighted sum of the accuracy of the determination and the predicted overhead for each of the selected subset of other nodes associated with the subset of other nodes in making the determination. In this way, the reinforcement learning agent may be trained to select a subset of the other nodes in a manner that provides a balance or compromise between accuracy and competing needs such as costs associated with energy efficiency and reducing traffic overheads.

It will be appreciated that the relative priorities may be changed in a dynamic manner, for example, at different times of day, for different types of traffic, for different priorities of traffic and or for different vendors operating on the communications network. These parameters may further be input to the reinforcement learning agent as state information.

The reinforcement learning agent may be trained by determining updated state information, s′, as a result of performing the action and training the reinforcement learning agent using the state, s, the action, a, the reward, r and the updated state, s′. As an example where the machine learning process comprises a Q learning process, for example, the training may comprise updating a Q-matrix, or neural network used for predicting Q values (in Deep-Q Learning) according to the (S,A,R,S′) information.

Training may be performed based on historical data (e.g. in an offline manner) or on a live system (in an online manner). In some embodiments, training may initially be performed on historical data and subsequently refined in the live environment.

In this way, a reinforcement learning agent may be trained to select subsets of a plurality of other nodes from which to obtain channel information in a manner that balances competing needs for accuracy and efficiency.

As an example, in one embodiment, the first model is a Deep-Q Learning reinforcement learning model and the machine learning process is a Q learning process. In this embodiment, step 302 of the method 300 may be performed as follows.

Deep Q-Learning Embodiment with Experience Replay for Sensing-Node Selection

### Definitions:

θ: represents the weights of the deep neural network for the derivation of the next state's Q-value
θ⁻: represents the weights from the previous iteration
TPₙ, w_{n,TP}: Throughput (of transferring sensing data) per node, and the corresponding weight.
Accₙ, w_{n,acc}: The node's detection accuracy per sensing node, and the corresponding weight.
EEₙ, w_{d}: The node's detection accuracy per sensing node, and the corresponding weight.
D_{T}, w_{d}: The delay of processing, and the corresponding weight.
EE_{n,T}, w_{n,EE}: The energy per sensing node, and the corresponding weight.
OH_{n,T}, w_{n,OH}: The overhead per sensing node, and the corresponding weight.
DS_{n,H}, DS_{n,S}: Previous average hard, soft sensing decisions per node.

A:={a₁, . . . a_{N}}, ∀ aₙ ε A represents the set of actions, where a₁ ε E {0,1} is whether node-0 is sensing, a₁=1, or not sensing, a₁=0, N is the number of sensing nodes

S=(DS_{n,H},DS_{n,S},OHₙ,EEₙ,D_{T},Accₙ,TPₙ,SINRₙ,P_{Trf,n},P_{Tx,n}, Av_{bat,n},Compₙ,T_{last,n})∀sₙεS

$$R = {\sum }_{n = 1}^{N} {w}_{n , O H} {OH}_{n} ( {s}_{n} , {a}_{n} ) + {\sum }_{n = 1}^{N} {w}_{n , EE} E {E}_{n} ( {s}_{n} , {a}_{n} ) + {w}_{d} {D}_{T} ( {s}_{n} , {a}_{n} ) + {\sum }_{n = 1}^{N} {w}_{n , a c c} A c {c}_{n} ( {s}_{n} , {a}_{n} ) + {\sum }_{n = 1}^{N} {w}_{n , TP} {TP}_{n} ( {s}_{n} , {a}_{n} )$$

Generally, different weightings in this reward function may be omitted (or set to zero) in order to optimise the decision based on different combinations of parameters.

For example, to optimise based just on accuracy, the reward function may take the form:

R=Σₙ₌₁^{N}w_{n,acc}Accₙ(sₙ,aₙ).

As another example, to decrease energy consumption and overhead while improving accuracy, the reward may be calculated according to:

$$R = {\sum }_{n = 1}^{N} {w}_{n , O H} {OH}_{n} ( {s}_{n} , {a}_{n} ) + {\sum }_{n = 1}^{N} {w}_{n , EE} E {E}_{n} ( {s}_{n} , {a}_{n} ) + {\sum }_{n = 1}^{N} {w}_{n , a c c} A c {c}_{n} ( {s}_{n} , {a}_{n} )$$

The reward function may be used as below.

### Algorithm-1:

1: Input: Action space A, mini-batch size L_{b}, weights of the rewards sub-functions, target network replacement or update frequency L⁻
2: Output: Optimal policy π* for N sensing nodes
3: Initialize replay memory D to capacity N
4: Initialize action-value function Q with random weights
5: Initialize target action-value function Q\hat{ } with weights θ⁻=θ
6: for Episode=1 to E do
   7: Initialize sequence s¹ and preprocessed sequence Ø¹=Ø¹(s¹)
   8: for timestep=1 to T do
   9: Choose an action aₜ
   10: With probability ϵ, a random action is performed
   11: Otherwise, choose aₜ=argmaxₐ Q(Ø1_(sₜ, a) from Q(s, A; θ)
   12: Broadcast messaging aₜ for N sensing nodes
   13: Execute chosen action a
   14: Receive reward R
   15: Receive state messages (at first node or fusion central)
   16: Update next network state s′
   17: Store tuple (s, a, r, s′) in replay memory D
   18: Randomly sample tuple (ss, aa, rr, ss′) of mini-batch size (L_{b}) from replay memory D
   19: Calculate target Q-value for each mini-batch transition
   20: yₜ^{DQN}=r if episonde i terminates at timestep+1, else yₜ^{DQN}=r+γ maxₐ′ Q (Øⱼ₊₁, a′, θ⁻)
   21: Train the Q-Network using (yₜ^{DQN}−Q (ss, aa)²) as loss and update the weights θ
   22: Reset θ⁻=θ every L⁻ steps
23: Update s←s′
24: Increment timestep by 1 repeat until timestep is >T, terminate
   repeat until Episode is >E, terminate

Turning now to other embodiments, in some embodiments the first model is a classification model. The skilled person will be familiar with classification models that can be trained to predict an output for given input data, based on training data comprising example inputs and corresponding ground truth (e.g. “correct”) outputs.

Example classification models include, but are not limited to Logistic Regression, Neural Networks, Convolutional Neural Networks, Graph based methods, Random Forest Models, XGBoost and Support Vector Machines.

A classification model may take as input any of the state variables described above with respect to the Reinforcement Learning embodiments. For example, the classification model may take as input one or more of:
historical success and/or fail rates of the plurality of other nodes in identifying whether the channel is accessible;
distances between the target node and the plurality of other nodes;
transmission powers of the plurality of other nodes;
power levels of the plurality of other nodes;
computational capabilities of the plurality of other nodes;
interreference levels experienced by the plurality of other nodes;
signal to noise levels at the plurality of other nodes;
a time interval since a previous transmission from the first node to the target node on the channel; and/or
an indication of a priority of traffic that is to be sent on the channel from the first node to the target node.

Based on such inputs, the classification model may provide as output an indication of the subset of other nodes from which to obtain channel information in order to determine whether the channel is in use. For example, the classification model may take as input an enumerated list comprising each of the other nodes and the values of the input parameters for each, and provide as output a list of enumerations associated with the selected subset of other nodes.

Generally, since, classification models are trained using supervised learning, the classification model may be trained to select a subset of nodes optimised with respect to one or more parameters, dependent on the ground truth outputs provided for each input test data. The ground truth (e.g. target/label) data can be obtained from an exhaustive search with an optimization function. The optimization function (and thus the ground truth labels) can be chosen to optimize energy, average accuracy, minimize overhead, etc.

In some examples, the classification model may be trained to select the subset of other nodes so as to optimise accuracy of the resulting determination of whether the channel is in use.

In one example the first model may be trained by minimising a loss function that comprises a first term to encourage the classification model to select a subset of nodes so as to optimise accuracy of the resulting determination of whether the channel is in use and one or more subsequent terms to optimise the one or more other parameters. The loss function may include a metric to avoid nodes which have been generating false data (due to any reason, including being malicious node, or hacked nodes).

For example, in embodiments where the one or more parameters comprise a parameter relating to overhead associated with making the determination, the loss function may comprise a term to encourage the classification model to select a subset of the other nodes that results in reduced overhead (e.g. compared to if all of the other nodes were selected, or compared to if accuracy were the sole requirement).

In another example, the classifier may minimize a loss function which is a weighted sum of the complementary (e.g. inverse) of correct detection and volume of measurement data to be transmitted.

In some embodiments, the loss function for the classification model may also comprise a metric to encourage the classification model to avoid (e.g. not select) nodes from the plurality of other nodes which have been generating false data (due to any reason, including being malicious, or hacked nodes).

In some embodiments the method 300 may further comprise determining a periodicity or frequency with which the selected subset of other nodes should obtain the channel information and/or the type of channel information that should be obtained.

For example, types of channel information that may be obtained include but are not limited to “hard decisions” e.g. a node may report whether according to its measurements, it considers the channel occupied or not (in other words an indication of whether the channel is in use, as determined by a respective other node); “soft decisions” e.g. the amount of sensed energy on the channel (in other words measurements of the channel quality as determined by a respective other node), or a probability of the channel being occupied as computed by the other node.

The type of channel information that should be obtained and/or reported may depend on the energy detected in the channel. For example, if high energy levels are detected in the channel, then it is very likely to be in use and therefore it may be appropriate for the other node to report a hard decision. Similarly, if the energy in the channel is very low then it is very likely that the channel is not in use and thus it may be appropriate for the other node to report a hard decision. For intermediate channel energy measurements, it may be more appropriate for a node to just report the measured energy level, or a probability that the channel is in use.

As an example, the first node may decide on two threshold levels (t1 & t2); if detected energy >t2, channel is not available (e.g. is busy), if detected energy <t1, channel is available (e.g. is idle). In these scenarios, these nodes report their hard decision. Nodes detecting energy between the thresholds t1 & t2, e.g. those for which there is low confidence in their hard decisions, report soft decision reporting instead.

The type of channel information that each other node in the subset of nodes should report may be determined by the first model. For example, the first model may be further trained to output a type of channel information that is to be obtained by the subset of other nodes. In embodiments where the first model is a reinforcement learning model, this may be achieved by increasing the action space available to the reinforcement learning agent. In embodiments where the first model is a classification model, the type of channel information that should be provided by each of the subset of other nodes may be added as an additional ground truth parameter in the training dataset.

In other embodiments, the type of channel information that should be obtained by each node may be determined or predicted by a second machine learning model. For example, in some embodiments, the method 300 may further comprise using a second model trained using a second machine learning process to output a type of channel information that is to be obtained by each of the subset of the other nodes.

In embodiments where the first model is a reinforcement learning agent, use of a second model to predict the type of channel information that should be obtained (e.g. instead of adding this as an additional output of the first model), may advantageously reduce the action space explorable by the first model.

Generally, the second machine learning model comprises either a classification or reinforcement learning agent, trained with the objective to predict which kind of sensed measurement (e.g., hard or soft sensing decision and measurements) should be sent, which kind of sensing technique should be used and which configuration parameters should be used when making the measurements.

Sensing techniques depend on the environment, but can be e.g., energy sensing or cyclo-stationary sensing.

### Measurement Category at UE and gNB Can Be One or More of:

Cell identifiers,
Energy based measurements, e.g. signal strength measurements,
Cyclostationary based measurement,
Wavelet based measurement,
Raw iq data (but this is very exhaustive method, not used), and/or
Probability of the channel being occupied.
   The Inputs to the Second Model may Comprise Measures such as:
The output of the first machine learning model (e.g. the identities of the selected subset of other nodes),
Each of the subset of other nodes capabilities, such as computation capabilities, numerology and bandwidth support, antenna number, etc.,
Historical accuracy of decision of the corresponding node, And/or
Network footprint.
   The States e.g. Inputs to the First Learning Model can Also be Input to the Second Model.

In embodiments where the second model is a second reinforcement learning agent, the second agent's action space contains N actions (N for each sensing node), each of the nodes' action contains characteristics of the sensing, i.e., hard or soft, and characteristics of the soft sensing decision (variance, mean, quantization level, periodicity, etc). The second agent aims to minimizing the cost (inverse of reward) function, which includes those metrics mentioned above with respect to the first model.

As described above, thresholds may be used to determine which type of reporting may be appropriate. With respect to the example described above where two threshold levels (t1 & t2) are defined (and if detected energy >t2, channel is busy, if detected energy <t1, channel is idle; then these nodes report hard decision. Between t1&t2, low confidence, then these nodes report soft decision reporting), in such an example, t1 & t2 may be updated continuously with feedback from the first node to the sensor node to increase/decrease low confidence interval in order to increase the efficiency.

Turning now to step 304, the method then comprises sending a message to cause the subset of other nodes to obtain the channel information.

For example, step 304 may comprise the first node sending a message to cause the subset of other nodes to provide or send the obtained channel information to the first node. The method 300 may further comprise receiving channel information reported/sent by the subset of other nodes to the first node.

Once the channel information is received by the first node from the subset of other nodes, the method 300 may further comprise determining whether the channel between the first node and the target node is in use based on the obtained channel information.

For example, the first node may aggregate or combine the channel information into a decision as to whether the channel is in use. The first node may generally combine the obtained channel information in any suitable manner, such as for example, using an average measure (mean), a maximum ratio combining method, an equal gain combining method and/or a selection combining method.

The manner in which the channel information from the subset of other nodes should be combined may be predicted or determined by the first model, the second model or by a third model trained using a third machine learning process.

For example, the first or second models may be further trained to determine a manner in which to combine the obtained channel information in order to determine whether the channel is in use. Such as, for example, a weighted combination of the channel information from the subset of other nodes with which to use in order to determine whether the channel is in use.

Alternatively, a third model trained using a third machine learning process may be used to determine a manner in which to combine the obtained channel information in order to determine whether the channel is in use. The third model may be trained, for example, to determine a weighted combination of the channel information from the subset of other nodes with which to use in order to determine whether the channel is in use.

The third model may be located at the first node (e.g. gNB or central node) and may generally be responsible for designing the weights to be used for aggregating the distributed channel information obtained from the selected subset of other nodes.

The aggregation of the channel information can be performed using a weighted polynomial function.

For example, the third model can be a third reinforcement learning agent trained to output the weights for each piece of channel information obtained from each of the nodes in the subset of other nodes. In this embodiment, the action performed by the third reinforcement learning agent may comprise adding a positive or negative increment to the weights (in other words tweaking the weights up and down) which are going to be used to aggregate the sensing measurement from distributed sensors.

The states of the third reinforcement learning agent can be, for example, one or more of:
True and false probabilities of all sensors,
previous aggregation weights,
geo location of all sensors,
historical/current sensed measurements.

The reward function of the third reinforcement learning agent may be set so as to maximize the detection accuracy. The algorithm used for the third reinforcement learning agent can be similar to that described above with respect to the embodiment where the first model is a first reinforcement learning agent, modified to take into account the above-mentioned rewards, actions, and states.

In some embodiments, the method 300 further comprises aggregating the channel information obtained by the subset of other nodes according to the output of the third reinforcement learning agent to produce an aggregated decision of whether the channel is in use.

In this way, machine learning models may be used to dynamically determine an optimal combination of channel information from a plurality of nodes in order to determine whether the channel is in use.

The aggregated decision output as above may be taken as the final decision of whether the channel is in use and this may be sent to the target node and actioned by the target node. In other words, the target node may send traffic over the channel if the aggregated decision indicates that that the channel is not in use (or may investigate another channel if the aggregated decision indicates that the channel is in use).

In other embodiments, the target node may receive the aggregated determination of whether the channel is in use from the first node and combine this with its own local determination.

It may, for example, take an average of the aggregated determination with its local determination. In another example, the target node may use the channel only if both the local determination and the received aggregated determination indicate that the channel is available for use.

In some embodiments, the manner in which the target node combines the aggregates determination with its local determination may be time sensitive. For example, a weighted combination of the local and aggregated determinations may be performed by the target node and the weights may depend on when the aggregated determination was received from the first node. For example, the weighting may be higher for the aggregated decision if it is newly received compared to if it was received some time ago (and may thus be out of date). In some embodiments the weight applied to the aggregated decision may be decayed (so as to give less weight to the aggregated decision) over time.

In some embodiments a further (e.g. fourth) machine learning model trained using a fourth machine learning process may be used to determine how the target node should combine the aggregated (or “global”) determination with its local determination.

For example, a Reinforcement Learning agent may be used that learns how to combine the local and aggregated decisions. For instance, the reward function of this agent may be the combined local and global sensing decision (which percentage of channel occupancy). The action would be an optimized local and global weight (which are used to combine local and aggregated global decisions). The state can be the current and previous accuracy of detection.

In this way, a UE may combine its own (up to date) determination of whether a channel is in use with a global or aggregated determination of whether the channel is in use, taking into account any time lag that might make the aggregated determination less reliable.

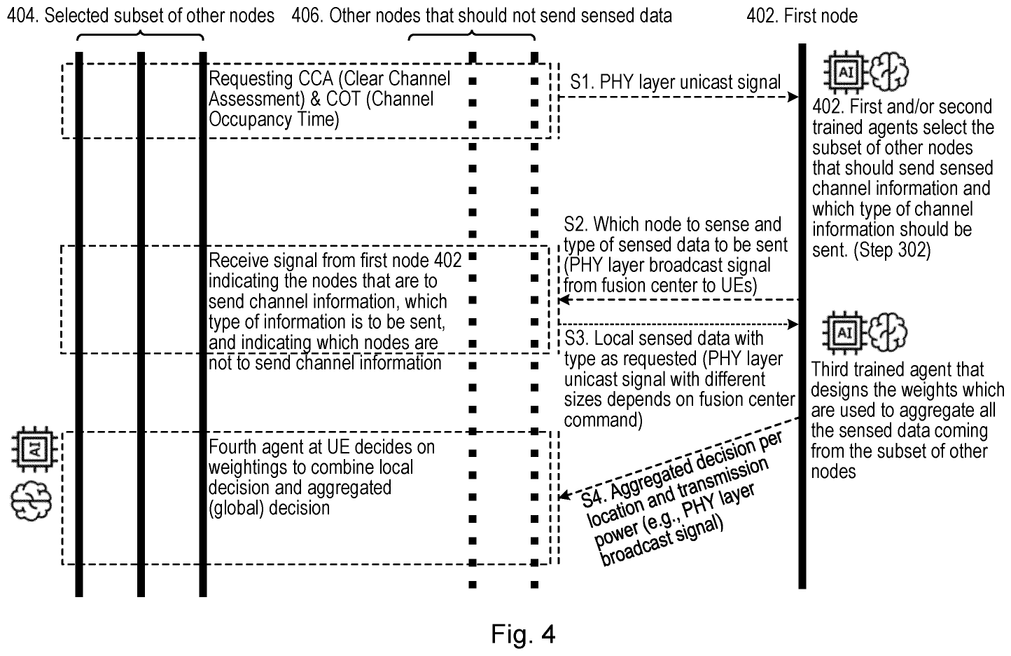

Turning now to FIG. 4 which shows a signalling diagram between a first node (or “Fusion Centre”) 402 and a plurality of other nodes 404, 406 in a communications network. In this embodiment the first node 402 is gNB and the other nodes 404 406 are UEs, as described above.

The information exchanged e.g. control signalling between the first node e.g. gNB and the plurality of other nodes (UEs), can be carried by different means including in-band signaling, on another unlicensed channel, on a licensed channel or any combination of above.

Some of the signals proposed herein can be summarized as:
S1. One of the plurality of other nodes 404, 406 requests to send channel information, this triggers the first node to perform a collaborative LBT process as described herein.

The first node receives signal S1 and uses a first model trained using a first reinforcement learning process to perform step 302 and select a first subset of the plurality of other nodes that should send channel information. The first model, or a second model may also determine the type of channel information that should be obtained by each of the selected subset of other nodes.
S2. The first node then performs step 304 and sends a message to cause the subset 404 of other nodes to obtain the channel information. The message may further indicate the type of sensing and the type of channel information that is to be sent back to the first node 402.

The subset 404 of other nodes receive the message and obtain the requested channel information.
S3. The subset of the plurality of nodes send the requested channel information to the first node.

At the first node 402, the received channel information is aggregated into a decision of whether the channel is in use (by the first node), using a third model trained using a third machine learning process to predict appropriate weights for use in aggregating the channel information obtained from the subset of nodes (as described above).
S4. The first node 402 then sends the aggregated determination of whether the channel is in use to all of the nodes in the plurality of other nodes.

Each other node (UE) may combine the aggregated decision with its local determination of whether the channel is in use. The manner in which the combination is performed by may be determined using a fourth machine learning model e.g. that predicts weights for a weighted combination of the aggregated decision and the local determination, as described above.

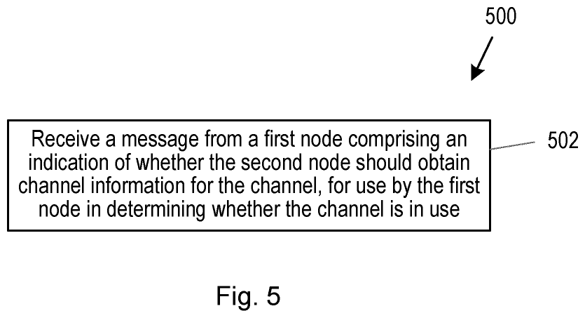

Turning now to other embodiments, FIG. 5 shows a method 500 from the point of view of one of the nodes in the selected subset of other nodes (which will be referred to herein as a second node). In step 502, the second node may receive a message from the first node comprising an indication of whether the second node should obtain channel information for the channel for use by the first node in determining whether the channel is in use. The message may further indicate the type of channel information (e.g. hard or soft as described above) that should be sent and/or the type of sensing that should be performed in order to obtain the channel information (e.g. cyclostationary measurements etc as described above) and/or a periodicity with which the channel information should be obtained.

If the indication indicates that the second node should send channel information, then the second node may obtain the requested channel information and send it to the first node.

As described in detail above, the first node may combine the channel information provided by the second node with channel information from other nodes in the subset of the plurality of other nodes to produce an aggregated determination of whether the channel is in use.

There are various advantages to the methods and nodes described herein. Both of the newly proposed signals herein, i.e., S2 and S4 in FIG. 4, have many benefits including improving energy efficiency of nodes and gNB, by selecting only specific and effective number of UEs to sense, with specific type of data to be send. Hence, saving UEs' battery and bandwidth consumption. Also, the proposed algorithm, does not enforce the Signal S2 to be sent so frequently, on the contrary, if the gNB algorithm is smart enough, this signal can be sent every minutes, hours, or days. The proposed method is expected to handle dynamic changes very well, because it collects information from an optimised subset of the other nodes (as in S3) unlike single LBT, which has input from a single node. In another embodiment, the control signals (or sensed data exchange signal) needed for these procedures can be performed on a license channel.

In summary, the disclosure herein poses as a key point for enabling NR-U technology (which is considered as a main technology in many applications). It provides a general framework, that improves collaborative sensing, utilizing several machine learning algorithms, communication, and sensing techniques. The framework herein implements a chain of steps between the first node (gNB) and the UE local node, that can be summarised as follows:
Step A, gNB, is responsible for selecting the subset of nodes that should report channel information. This is done by classification or RL algorithm where agents are trained to select nodes that can highly contribute to the sensing output and discard the remaining nodes), as described above.
Step B, gNB, is responsible to select and learn the type of measurement to be reported by each of the selected subset of other nodes, i.e., some nodes report their hard decision others report soft decision.
Step C, gNB, is responsible for determining weights to combine the channel information from the subset of other nodes into an aggregated decision of whether the channel is in use.
Step D, UE, is responsible to learn how to aggregate its local data and the aggregated decision received from Step C.

Such methods overcome a critical problem (e.g., the hidden node problem) via utilizing and connecting machine learning techniques in different nodes (e.g., gNBs and UEs) while enhancing the detection accuracy. Furthermore, this framework can reduce the network footprint, e.g., it can reduce the amount of signaling needed from the nodes whilst still enhancing accuracy. Another core aspect of the disclosure herein is that it can reduce the complexity and improve the energy efficiency of making accurate decisions as not all UEs (which don't have computational ability and enough energy) need to participate in sensing and sending the data to first node, however these can still obtain the results of sensing.

Variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality. A single processor or other unit may fulfil the functions of several items recited in the claims. The mere fact that certain measures are recited in mutually different dependent claims does not indicate that a combination of these measures cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

1. A computer implemented method performed by a first node in a communications network for use in determining whether a channel between the first node and a target node is in use, the method comprising:
selecting, from a plurality of other nodes that are suitable for making measurements on the channel, a subset of the other nodes from which to obtain channel information in order to determine whether the channel is in use, the selection being performed using a first model trained using a first machine learning process to select the subset of other nodes based on accuracy of the resulting determination of whether the channel is in use; and
sending a message to cause the subset of other nodes to obtain the channel information.

2. The method as in claim 1, wherein the first model is trained to select the subset of other nodes so as to optimise accuracy of the resulting determination of whether the channel is in use.

3. The method as in claim 1, wherein the first model is further trained to select the subset of other nodes based on values of one or more other parameters; and wherein the first model is trained to optimise the accuracy of the resulting determination of whether the channel is in use and the values of the one or more other parameters.

4. The method as in claim 3, wherein the one or more other parameters comprises a measure of overhead associated with making the determination.

5. The method as in claim 4, wherein the measure of overhead is one or more of:
signalling overhead associated with making the determination;
volume of traffic flow through the communications network associated with making the determination;
computational energy used by the subset of nodes associated with making the determination; and
energy efficiency associated with making the determination.

6. The method as in claim 1, wherein the first model is a reinforcement learning agent;
wherein the step of selecting is performed by the reinforcement learning agent as an action, a; and
wherein the reinforcement learning agent is rewarded for the action based on the accuracy of the resulting determination of whether the channel is in use.

7.-11. (canceled)

12. The method as in claim 6, wherein the first model is further trained to select the subset of other nodes based on values of one or more other parameters; and wherein the first model is trained to optimise the accuracy of the resulting determination of whether the channel is in use and the values of the one or more other parameters, wherein the reinforcement learning agent receives a reward based on a reward function that rewards the reinforcement learning agent based on relative priorities of the accuracy and the values of the one or more other parameters, so as to apply a trade-off between the accuracy and the one or more parameters according to the relative priority of each parameter.

13. (canceled)

14. (canceled)

15. The method as in claim 1, wherein the first model is a classification model, wherein the first model is further trained to select the subset of other nodes based on values of one or more other parameters; and
wherein the first model is trained to optimise the accuracy of the resulting determination of whether the channel is in use and the values of the one or more other parameters, wherein the first model was trained by minimising a loss function that comprises a first term to encourage the classification model to select a subset of nodes so as to optimise accuracy of the resulting determination of whether the channel is in use and one or more subsequent terms to optimise the one or more other parameters.

16. (canceled)

17. (canceled)

18. The method as in claim 15, wherein the first model is a classification model, and wherein the first model was trained using a training dataset comprising example inputs and ground truth subsets of the other nodes from which to obtain channel information.

19. (canceled)

20. The method as in claim 1, wherein the first model is further trained to output a type of channel information that is to be obtained by the subset of other nodes.

21. The method as in claim 1, further comprising using a second model trained using a second machine learning process to output a type of channel information that is to be obtained by the subset of the other nodes.

22. The method as in claim 20, wherein the type of channel information comprises:
an indication of whether the channel is in use, as determined by a respective other node; or
measurements of the channel quality as determined by a respective other node.

23. The method as in claim 1, comprising:
receiving the obtained channel information transmitted from the subset of other nodes; and
determining whether the channel between the first node and the target node is in use based on the obtained channel information.

24. The method as in claim 23, wherein the first model is further trained to determine a manner in which to combine the obtained channel information in order to determine whether the channel is in use.

25. (canceled)

26. The method as in claim 23, further comprising using a third model trained using a third machine learning process to determine a manner in which to combine the obtained channel information in order to determine whether the channel is in use.

27.-32. (canceled)

33. A first node in a communications network for determining whether a channel between the first node and a target node is in use, the first node comprising:
a memory comprising instruction data representing a set of instructions; and
a processor configured to communicate with the memory and to execute the set of instructions, the set of instructions, when executed by the processor, causing the processor to:
select, from a plurality of other nodes that are suitable for making measurements on the channel, a subset of the other nodes from which to obtain channel information in order to determine whether the channel is in use, the selection being performed using a first model trained using a first machine learning process to select the subset of other nodes based on accuracy of the resulting determination of whether the channel is in use; and
send a message to cause the subset of other nodes to obtain the channel information.

34. The first node as in claim 33, wherein the first model is trained to select the subset of other nodes so as to optimise accuracy of the resulting determination of whether the channel is in use.

35. A method performed in a second node for determining whether a channel between a first node and a target node is in use, the method comprising:
receiving a message from the first node comprising an indication of whether the second node should obtain channel information for the channel for use by the first node in determining whether the channel is in use.

36. The method as in claim 35, wherein the message further indicates one or more of a type of channel information to obtain, a type of sensing to perform in order to obtain the channel information and a periodicity with which the channel information should be obtained.

37. (canceled)

38. A second node in a communications network for determining whether a channel between a first node and a target node is in use, wherein the first node is configured to:
receive a message from the first node comprising an instruction to cause the second node to obtain channel information for the channel.

39.-42. (canceled)
